(19) United States
(12) Patent Application Publication
(10) Pub. No.: US 2013/0314893 A1
(43) Pub. Date: Nov. 28, 2013

(54) HIGH BRIGHTNESS ILLUMINATION SYSTEM AND WAVELENGTH CONVERSION MODULE FOR MICROSCOPY AND OTHER APPLICATIONS

(71) Applicant: Lumen Dynamics Group Inc., Mississauga (CA)

(72) Inventor: Michel Paquette, Etobicoke (CA)

(73) Assignee: Lumen Dynamics Group Inc., Mississauga (CA)

(21) Appl. No.: 13/900,089

(22) Filed: May 22, 2013

Related U.S. Application Data
(60) Provisional application No. 61/651,130, filed on May 24, 2012.

(51) Int. Cl. G02F 1/35; F21V 9/16

(52) U.S. Cl. CPC G02F 1/353; F21V 9/16
USPC 362/84; 359/326

(57) ABSTRACT

An illumination system comprising a laser light source and a wavelength conversion module for generating high brightness illumination by photoluminescence. The wavelength conversion module comprises an optical element comprising a wavelength conversion medium, set in a mounting for thermal dissipation, and an optical concentrator. The shape of the optical element and its reflective surfaces provides improved light extraction at the converted wavelength, and allows for more effective cooling. It provides a compact light source with a configuration suitable for applications that require high brightness and narrow bandwidth illumination at a selected wavelength, e.g. for fluorescence microscopy, or other applications requiring étendue-limited optical fiber coupling. The system, which preferably uses a solid state laser diode, provides an alternative to conventional arc lamps, and addresses limitations of other available solid state LED light sources to provide high brightness at some wavelengths, particularly in the 580nm to 630nm range.

### CROSS-REFERENCE TO RELATED APPLICATIONS

This application claims priority from U.S. Provisional patent application No. 61/651,130, filed May 24, 2012, which is incorporated herein by reference in its entirety.

### FIELD OF THE INVENTION

This invention relates to high brightness light sources for illumination systems for applications such as microscopy and fluorescence microscopy, and particularly for fiber coupled illumination systems.

### BACKGROUND

There is a need for high optical radiance illumination sources to provide optical fiber coupled illumination for microscopy and other applications. Conventional illumination systems typically utilize short arc lamps such as high pressure mercury, metal halide, and xenon. These lamps are capable of very high radiance and are therefore suitable sources for étendue limited fiber optic coupled illumination systems.

Problems associated with these conventional lamp technologies, however, include short lifetime, temporal variation of the output power, high voltage operation (typically kilovolts required to strike the lamp), and use of mercury, which is now seen as an environmental hazard and is in the process of undergoing regulations to limit use in numerous countries throughout the world.

It is now recognized that some Light Emitting Diodes (LEDs) may provide sufficient radiance to replace more traditional light sources in some applications, including microscopy illumination systems. Solid state LEDs provide advantages relative to conventional arc lamps, such as, much improved lifetime, lower cost of ownership, lower power consumption (enabling some battery operated portable devices), decreased cooling requirements, and freedom from mercury. Additionally, LED light sources can be readily modulated, which can be a significant advantage in many applications.

Nevertheless, despite technological advances in LED technology, high brightness LED light sources are not available to cover all wavelengths required for illumination systems for microscopy or fluorescence microscopy, for example. In particular, LED devices still do not match the radiance of traditional arc-lamps in some regions of the visible spectrum, especially in the 540 to 630 nm spectral band.

While laser diodes are a special class of LEDs that can produce high intensity, narrow bandwidth, coherent illumination for some wavelengths, these are also not available for all required wavelengths. Also, speckle or optical artifacts produced by coherent illumination may be undesirable for some applications.

LEDs can be used in combination with luminescent materials, i.e. fluorescent materials or phosphors, to generate light of wavelengths that are outside the range emitted directly by the LEDS. Thus, it is well known in the art of LED lighting and illumination to use a UV or blue LED together with a phosphor, e.g. a yellow phosphor, to obtain light emission of a desired color range, and/or to combine or mix output from multiple LEDs of different colors, e.g. as an array of blue, red and green LEDs, to provide white light of a desired Color Rendering Index (CRI) or Correlated Color Temperature (CCT).

Applications such as microscopy may require broadband or white light illumination, or, may require a relatively narrow band illumination of a particular wavelength range in the UV, visible or IR spectral regions. Fluorescence microscopy and analysis, for example, may require illumination of a biological sample with a relative narrow band of illumination of a particular wavelength that is absorbed by a selected fluorophore or marker in the substance under test.

U.S. Pat. No. 7,898,665 to Brukilacchio et al., issued Mar. 1, 2011, entitled “Light Emitting Diode Illumination System,” for example, discloses a system comprising an arrangement of multiple LEDS that are coupled to a fluorescent rod which emits at a different wavelength to provide sufficiently high brightness illumination for applications such microscopy or endoscopy. Different wavelengths from more than one fluorescent rod may be combined to provide a desired color or spectrum of illumination. United States Patent Publication No. 2011/038138 to Cardullo, published Feb. 17, 2011, entitled “Visible Light Generated Using UV Light Source” discloses another arrangement using UV or visible LEDs to generate visible light by scattering from surfaces coated with a suitable material such as a phosphor or quantum dot material that emits a broader spectrum of light over a desired wavelength range. The performance of these systems may be limited by quantum yield of the wavelength conversion process, and by the need for thermal management to dissipate heat from the LEDs and from the fluorescent material. Systems that require combining output of multiple LEDs to obtain sufficient brightness over a particular spectral range may be quite large and require significant cooling.

To address issues of thermal degradation of a phosphor powder, U.S. Pat. No. 7,070,300 to Harbers et al., issued Jul. 4, 2006, entitled “Remote Wavelength Conversion in Illumination Device”, for example, discloses an arrangement in which a light source and a phosphor powder are separated for improved thermal management.

In another example, U.S. Pat. No. 8,096,668 to Abu-Ageel, issued Jan. 17, 2012, entitled “Illumination Systems Utilizing Wavelength Conversion Materials”, discloses an arrangement comprising wavelength conversion material within a tapered a hollow lightguide that provides light recycling to improve optical efficiency for compact projection systems.

However, these arrangements do not effectively address requirements for microscope illumination systems. Moreover, because of the different form factor and light distribution pattern of the radiation output of LED light sources and arc lamps, the requirements for optical systems for effectively coupling of illumination systems using LED light sources are different from those using conventional arc lamps. For applications such as microscopy, high brightness, &endue limited optical fiber coupling or light guide coupling of the microscope illuminator may be required. For example, the light source may need to be coupled to a 3 mm or 1 mm aperture of an optical fiber input. It would be desirable to have more compact, high brightness light sources to facilitate étendue limited coupling using optical fibers or light guides.

Thus, there is a need for improved or alternative high optical radiance illumination sources, particularly those that can provide optical fiber coupled illumination for microscopy and other applications.

### SUMMARY OF INVENTION

The present invention seeks to overcome or mitigate one or more disadvantages of known high brightness illumination systems, or at least provide an alternative, for applications such as fluorescence microscopy.

One aspect of the present invention provides an illumination system comprising: a laser light source; a wavelength conversion module comprising: a high thermal conductivity holder or mounting; an optical element comprising a wavelength conversion medium (i.e. photoluminescent material) supported by and in thermal contact with the holder; an input/output aperture of the optical element for coupling light of a first wavelength λₗ from the laser light source into the optical element for exciting photoluminescence emission therein at a converted wavelength λ_{f} and for extracting the photoluminescence emission; an optical concentrator coupled to the aperture; and reflector means comprising a reflective surface or surfaces of the optical element for directing photoluminescence emission from the wavelength conversion medium into the optical concentrator and coupling the concentrated photoluminescence emission to an output aperture of the illumination system.

The reflector means of the optical element comprises a reflective surface or surfaces thereof in thermal contact with the holder. Beneficially, the reflective surface or surfaces comprises a dichroic coating of a material having a high reflectance at the converted wavelength and preferably also at the laser wavelength.

Advantageously, in a preferred embodiment, the optical element is shaped as a cone, which may be a simple cone, a truncated cone or other conical shape. The reflector means comprises a conical surface thereof, which is coated with an optical coating having a high reflectance, preferably >94%, at the converted wavelength. The surface also preferably has a high reflectance at the laser wavelength. A conical shape is simple to manufacture and provides effective extraction of the converted wavelength.

The optical element may comprise a body having a first portion comprising the wavelength conversion medium and a reflector portion optically coupled thereto provide said reflective surfaces. For example, the wavelength conversion medium may take the form of a cylindrical first portion of a body of the optical element 130, having a highly reflective surface or coating, and a second portion of the body is shaped as a reflector, such as a conical reflector. The conical reflector body preferably comprises an optical medium that is substantially transparent (non-absorbing) at the converted wavelength and at the laser wavelength and index matched to the wavelength conversion medium, and the conical surface is highly reflective at both the converted wavelength and at the laser wavelength.

In other embodiments, the optical element comprises a body comprising said wavelength conversion medium having a shape, such as a simple geometric shape, comprising one of a cylinder, a cube, a rectangle, a cone, and a pyramid, or combinations thereof, and the reflector means comprises a reflective facet or facets of the shape, that are highly reflective, i.e. coated with a reflective coating, which may be a broadband coating or a dichroic coating, to direct photoluminescence emission generated within the wavelength conversion medium towards the output aperture of the optical element. For example, the wavelength conversion medium may comprise a cylindrical portion of the body coupled to a reflector portion of the body of an optical medium having a conical shape, and wherein at least facets of the reflector portion and walls of the cylindrical portion comprises a coating having a high reflectivity at the converted wavelength and at the laser wavelength. For wavelength conversion elements with tapered reflective surfaces such as provided by a conical or pyramidal reflector geometry for example, which may be a truncated cone, it is advantageous for the reflective facets to be polished and comprise a reflective coating with >94% reflectance at the converted wavelength and at the laser wavelength. Thus, the reflective surfaces of the optical element effectively direct the converted wavelength towards the output aperture. When the wavelength conversion element has high reflectivity at the laser wavelength, it increases the path length of the laser beam within the conversion medium and permits a more complete absorption of the laser energy by the conversion medium.

Desirably, the optical element should also have sufficient depth-or dimension along the optical axis to provide sufficient absorption, but not be so deep that the converted wavelength is trapped by geometry or absorption.

For wavelength conversion elements of a cubic or cylindrical shape, i.e. with parallel opposing facets, it is advantageous that reflective surfaces have a surface structure or texture to produce diffuse reflectance and reduce specular reflection, thereby reducing probability of cavity modes. Beneficially, the reflectance of these surfaces is preferably >94% reflectance, at both the laser wavelength and at the converted wavelength.

More complex shapes may be used but these tend to add to design complexity and manufacturing costs. A conical or pyramidal wavelength conversion element is relatively simple to manufacture and provides good performance.

The wavelength conversion medium may comprise a single crystal material, a polycrystalline material, a ceramic material or resin, or other host matrix material comprising the selected material. Examples, of suitable wavelength conversion media comprise one of: a) cerium doped yttrium aluminum garnet (Ce:YAG), Ce:YAG doped with praseodymium and/or terbium, or other rare earth doped garnet material that emits luminescence at a desired wavelength, or b) titanium doped sapphire or other materials capable of amplified spontaneous emission.

Another aspect of the invention provides an wavelength conversion module for an illumination system comprising: a high thermal conductivity mounting holder; an optical element having a body comprising at least in part a wavelength conversion medium capable of laser excitation by light of a first wavelength to generate photoluminescence emission at a converted wavelength, the optical element being held in the holder in thermal contact therewith; an optical concentrator coupled to an optical aperture of the optical element; the body of the optical element having a shape defined by one or more reflective surfaces forming a substantially non-resonant cavity to receive light of the first wavelength through the optical aperture into the wavelength conversion medium, and wherein the one or more of said surfaces form a reflector for directing photoluminescence from the wavelength conversion medium towards the optical aperture of the body into the optical concentrator.

The wavelength conversion medium may comprise one of Ce:YAG, Ce:YAG co-doped with terbium or praseodymium or other rare earth; other rare earth doped garnet; or titanium doped sapphire or other materials capable of amplified spontaneous emission.

The wavelength conversion medium may be a single crystal, a polycrystalline material, or a ceramic material.

In a preferred embodiment, the body of the optical element comprises a cone, wherein conical surfaces thereof form the reflector. The body of the optical element may alternatively have a geometric shape comprising a cube, a cylindrical rod, a cone, a multifaceted pyramid, or similar shapes that are simple to manufacture. Other more complex shapes may be used but add to manufacturing cost. For example, a shape that may be manufactured cost effectively comprises a first portion shaped as a cylinder, and a reflector portion shaped as a conical profile reflector.

The body of the optical element may comprise a first portion comprising the wavelength conversion medium and a reflector portion comprising an index matched optical medium that is substantially transparent to the converted wavelength. The reflector portion may comprise an index matched optical medium that is substantially transparent to the converted wavelength and the excitation wavelength.

In one embodiment, the optical element has a first portion shaped as a cylinder, and the reflector portion is shaped as a conical profile reflector, and the optical concentrator comprises a concentrator having a conical profile.

Alternatively, the optical concentrator comprises a compound parabolic concentrator, or other complex profile concentrator. The optical concentrator may be an air concentrator. Alternatively, it may be a dielectric concentrator that preferably comprises an optical medium that is index matched to that of the optical element. The latter helps to improve extraction of light and also assists with thermal dissipation.

Advantageously, the holder acts as a heat spreader and the system may further comprise, a heatsink, or other cooling means for air cooling and/or liquid cooling.

The thermally conductive mounting/holder may also be extended around the optical concentrator.

Thus, a light source for an illumination system and a wavelength conversion module according to preferred embodiments of the invention, as described herein, have the potential of meeting and exceeding the output of the best arc lamps systems available today, while overcoming at least some of the limitations of high brightness LED light sources.

The foregoing and other objects, features, aspects and advantages of the present invention will become more apparent from the following detailed description, taken in conjunction with the accompanying drawings, of preferred embodiments of the invention, which description is by way of example only.

### BRIEF DESCRIPTION OF DRAWINGS

FIG. 1 is a schematic diagram of an illumination system comprising a wavelength conversion module according a first embodiment of the invention;

FIG. 2 illustrates the absorption and emission spectrum of a wavelength conversion medium comprising Ce:YAG fluorescent material;

FIG. 3 shows an enlarged cross-sectional view of the wavelength conversion module of FIG. 1, comprising the cylindrical rod-shaped wavelength conversion medium (i.e. fluorescent material) and conical-profile optical concentrator;

FIGS. 4, 5, 6 and 7 illustrate schematically the results of optical modeling of wavelength conversion modules according embodiments of the invention, wherein the wavelength conversion medium and its reflector surfaces are shaped respectively, as a cube, a cylindrical rod, a cone and a multifaceted pyramid;

FIG. 8 illustrates an example of a plot showing the converted radiation energy reaching the surface of the fluorescent material versus angle of incidence for the wavelength conversion module shaped as a cylindrical rod and as a cone, respectively;

FIG. 9 illustrates schematically a cross-sectional view of a wavelength conversion module according to a second embodiment, wherein the wavelength conversion medium comprises a cylindrical rod-shaped portion of fluorescent material coupled with a conically shaped reflector portion of the same fluorescent material and a conical-profiled optical concentrator;

FIG. 10 illustrates schematically the results of optical modeling of a wavelength conversion as shown in FIG. 9;

FIG. 11 shows a schematic diagram of an illumination system comprising an optical wavelength conversion module according to a second embodiment of the invention;

FIG. 12 illustrates schematically an illumination system according to a third embodiment of the invention comprising a single laser and laser beam switching device and a plurality of light wavelength conversion modules; and

FIG. 13 illustrates schematically an illumination system according to a fourth embodiment of the invention comprising a plurality of lasers and wavelength conversion modules.

### DESCRIPTION OF PREFERRED EMBODIMENTS

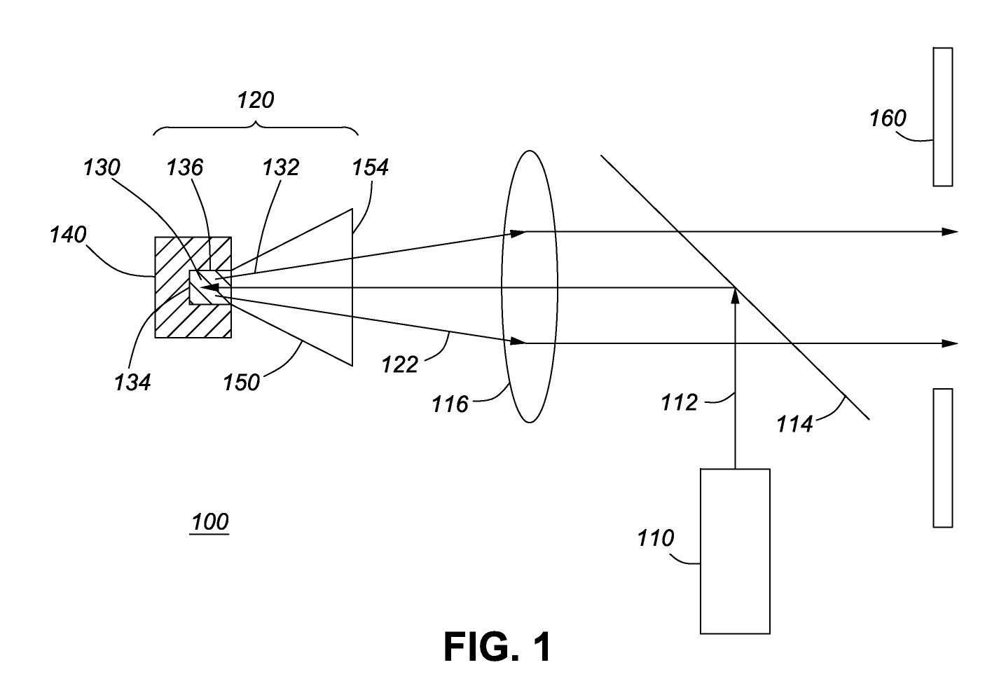

A schematic diagram of an illumination system 100 according to a first embodiment of the invention is shown in FIG. 1. It comprises a laser light source 110 and an optical wavelength conversion module 120, which comprises an optical element 130 mounted within a support or holder 140 of thermally conductive material, and an optical concentrator 150. The laser source 110 generates optical radiation 112 that is collimated or focused and directed towards to the optical element 120 via optical components comprising a dichroic minor 114, lens 116 and the optical concentrator 150. The laser radiation 112 enters the optical element 130 of the wavelength conversion module 120, via a surface 132 of optical element 130 that mates with the aperture 152 of optical concentrator 150. The optical element 130 comprises a wavelength conversion medium 131, i.e. a fluorescent material that absorbs optical radiation 112 from the laser source 110 and emits photoluminescence or fluorescence 122 at a different wavelength, characteristic of the fluorescent material 131. The fluorescence, or wavelength converted radiation, 122 is directed towards the output aperture 160 of the apparatus via the optical concentrator 150, lens 116, and dichroic mirror 114.

The optical element 130 has a body comprising the wavelength conversion medium 131 which is selected to provide strong fluorescence emission at a desired wavelength and with a suitable bandwidth, for a particular application, e.g. for use as an illumination source for microscopy, fluorescence microscopy or other application. The laser source 110 is chosen such that its emission wavelength is absorbed by the fluorescent material 131 and causes light emission, i.e. photoluminescence or fluorescence, at a wavelength 122 different from the excitation wavelength 112 and characteristic of the fluorescent material 131. As an example, a suitable wavelength conversion medium or fluorescent material 131 for optical element 130 may be referred to as a scintillation crystal, such as cerium doped yttrium aluminum garnet (Ce:YAG).

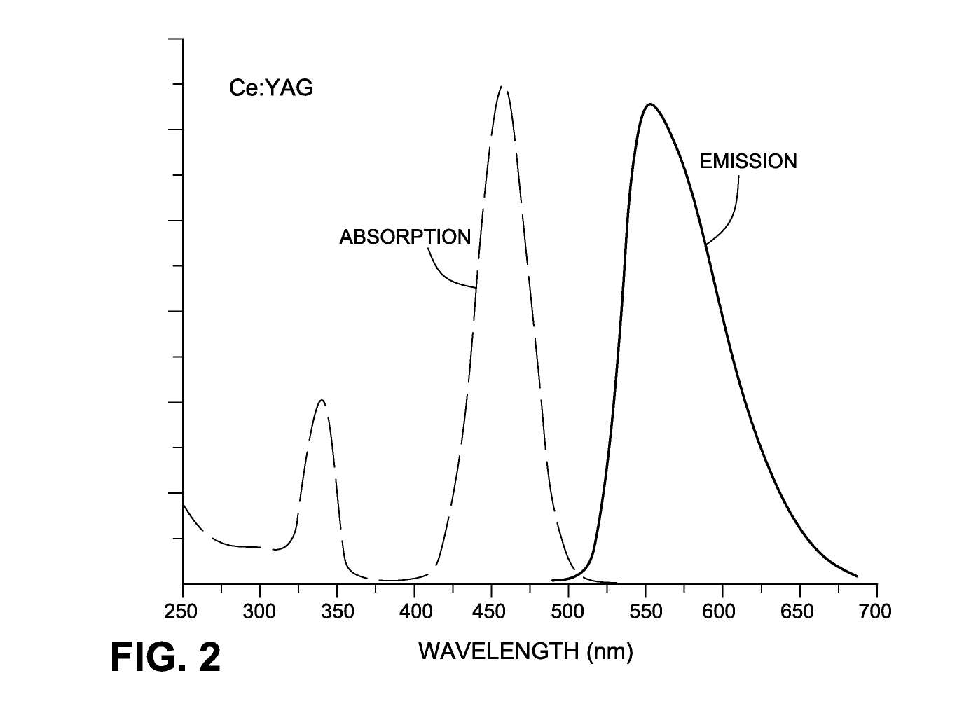

FIG. 2 shows the typical optical absorption and emission spectra of Ce:YAG fluorescent material. This material has an absorption spectrum characterized by a strong absorption peak at about 450 nm and the emission spectrum that has a peak at around 550 nm. Assuming that the wavelength of the excitation laser 112 is chosen to be within the optical absorption spectrum of the fluorescent material, preferably near the absorption peak at 450 nm, the laser radiation 112 will be absorbed by the fluorescent material, and some of the absorbed energy will be converted to fluorescence emission at a different wavelength 122, i.e. in this example, an emission band with a peak around 550 nm. The rate at which absorption occurs depends on several parameters, including the concentration of the dopant, i.e. Ce, in the fluorescent material and follows the Beer-Lambert law. For example, a fluorescent material Ce:YAG with a dopant concentration of cerium within the YAG lattice of 0.3% has an optical absorption coefficient of approximately 8 cm⁻¹ at an optical wavelength of 450 nm. This means that if the excitation laser radiation is at 450 nm, 55% of the radiation will be absorbed within 1 mm the fluorescent material. In the case of Ce:YAG, a large proportion of the incident energy that is absorbed will be converted to fluorescence at another wavelength, as determined by the quantum yield, Φ of the fluorescent material 131. Quantum yield may be defined as Φ=photons emitted/photons absorbed. Thus, desirably, the material 131 has a high quantum yield.

As an example, and as illustrated in FIG. 2, Ce:YAG is a material which is suitable for applications requiring light emission in a wavelength band around 550 nm. Alternatively other YAG or related garnet materials doped with cerium or other rare earth elements, or similar materials, may be selected as the wavelength conversion medium to provide emission at other wavelengths, as will be described in detail below.

For some applications, such as, fluorescence microscopy, for example, it may be desirable to provide illumination with a relatively narrow bandwidth, e.g. 30 nm. Thus, if the wavelength conversion medium 131 provides a broad emission spectrum, the illumination system shown in FIG. 1 may additionally include a filter, e.g. bandpass filters, as appropriate. Alternatively, in some preferred embodiments, as described below, a fluorescent material 131 for the wavelength conversion element 130 is selected that provides strong emission with a relatively narrow emission bandwidth.

Since only part of the energy from the laser radiation is converted to photoluminescence, the remaining energy is dissipated non-radiatively, i.e. as heat. Thus, the optical element 130 is mounted so as to provide good thermal contact of the wavelength conversion medium 131 with the holder, and holder 140 preferably comprises a thermally conductive material, such as a copper slug, or other material with high thermal conductivity, i.e. to provide for thermal dissipation from the optical element 130. Optionally, the holder 140 may additionally be thermally coupled to or comprise additional elements (not shown) for thermal management, such as a finned heatsink together with air or liquid cooling, e.g. a fan, heatpipe, or other cooling system as typically used for thermal management of semiconductor devices and optical devices.

In addition to appropriate selection of the fluorescent material or wavelength conversion medium 131, other optical parameters of the system, in particular, the geometry or shape and size of the optical element 130 and optical concentrator 150, are important in determining the optical performance and controlling the optical output and matching it to the aperture of the system for which it is designed. The following sections will discuss these design considerations in more detail.

Selection of Suitable Fluorescent Materials

The choice of fluorescent material depends in part of the amount of optical energy is needed for the application. For example, for fluorescence microscopy, a light source providing about 200 mW, over a desired 30 nm bandwidth range, may be required.

Besides quantum yield, other factors affect the usable converted energy. One of these factors is the number of atoms available in the material available for the optical conversion process. If an atom is in an excited state because it has absorbed a radiation then it is not available for absorbing radiation until it first de-excites. This de-excitation occurs either by emission of radiation energy at the converted wavelength or by non-radiative processes. The average time for a fluorescent material to de-excite is known in the art as the fluorescence lifetime. If the fluorescence lifetime of the material is long enough, and there is enough exciting radiation, there could be situations where a large fraction of atoms are excited simultaneously. This situation would have the effect of saturating the wavelength conversion process and would prevent high powers being generated in the conversion process. In this context, fluorescent materials that have short lifetimes would be less prone to saturation than materials with long lifetimes, and the fluoresecent lifetime is part of the design consideration.

Referring to the above, there is class of photoluminescent or fluorescent material, called scintillation crystals, which emit light on excitation by electrons or photons, and which have short fluorescence lifetimes. These materials could be used for embodiments of the present invention if the optical absorption characteristics match those of the emission characteristics of the laser source and the converted spectrum (i.e. fluorescence emission spectrum) corresponds to the needs of the specific application. One example of a suitable scintillation crystal is single crystal cerium doped yttrium aluminum garnet, i.e. Y₃Al₅O₁₂:Ce³⁺ (Ce:YAG). Other related rare earth doped garnet materials may also be suitable, as described in the following paragraphs, providing the fluorescent material has a fluorescence lifetime such that it does not saturate, and a suitable absorption and emission spectra for the intended application.

Rare Earth Doped Garnet Materials

Ce:YAG fluorescent material can be synthesized or doped with other materials, e.g. other rare earth elements, to provide an emission spectrum or converted spectrum peak that corresponds to the needs of a specific application. For example, but not limited to, the Ce:YAG can be co-doped with praseodymium to provide a converted spectrum that has typical Ce:YAG characteristics but with enhanced power at 610 nm. Another example, the Ce:YAG can be synthesized with terbium which has the effect of shifting the converted spectrum towards longer wavelengths. In this case the terbium substitutes some of the ytterbium atoms in the crystal lattice. The spectral shift is related to the ratio of terbium to ytterbium in the fluorescent material, and can provide a converted spectrum peak shifted to 575 nm.

Besides Ce:YAG, there are other related fluorescent materials that could be used in embodiments of the present invention. For instance, cerium doped lutetium aluminum garnet (Ce: LuAG) fluorescent material is known in the art to have an emission peak at 535 nm, instead of 550 nm that is typically found for Ce:YAG.

See for example: Ho Seong Jang, Won Bin Im, Dong Chin Lee, Duk Young Jeon, Shi Surk Kim, “Enhancement of red spectral emission intensity of Y₃Al₅O₁₂:Ce³⁺ phosphor via Pr co-doping and Tb substitution for the application to white LEDs,” Journal of Luminescence, Volume 126, Issue 2, October 2007, Pages 371-377; Hong Jeong Yu, Wonkeun Chung, Hyunchul Jung, Sun Hee Park, Sung Hyun Kim, “Luminous properties of color tunable strontium thio-selenide phosphors for LEDs application,” Materials Letters, Volume 65, Issues 17-18, September 2011, Pages 2690-2692; Jung-Sik Shin, Hyun-Joon Kim, Yong-Kwang Jeong, Kwang-Bok Kim, Jun-Gill Kang, “Luminescence characterization of (Ca₁₋ₓSrₓ)(S_{1-y}Se_{y}):Eu²⁺, M³⁺ (M=Sc and Y) for high color rendering white LED”, Materials Chemistry and Physics, Volume 126, Issue 3, 15 April 2011, Pages 591-595.

These fluorescent materials are typically synthesized as single crystals. Alternatively, these materials may be provided in polycrystalline form or in a suitable host matrix, such as a transparent ceramic structure. These ceramic materials may offer manufacturing and cost advantages over single crystal material, particularly for wavelength conversion elements of more complex geometric shapes.

An alternative to scintillation crystal fluorescent materials would be what is known in the art as laser crystals. These crystals typically have a nominally much longer fluorescent lifetime than scintillation crystals. Additionally, when certain conditions are met, atoms within the material can de-excite in a special manner known in the art as stimulated emission. Lifetime is reduced when these conditions are met and stimulated emission occurs. Embodiments of the invention could use laser crystals such as, for example but not limited to, titanium doped sapphire (Ti:sapphire), praesodymium doped yttrium lanthanum fluoride (Pr:YLF), or neodymium doped YAG (Nd:YAG) and other materials that are known to be capable of stimulated emission.

It is well known in the art of laser engineering to use such materials in a particular class of device called a laser oscillator, in which a laser crystal or other laser material is placed within a resonant optical cavity. However, the scope of the present invention is not intended to extend to laser oscillators and the design of the optical element of the illumination system is not intended to create what is known in the art as eigenmodes, cavity modes or optical resonances which characterize laser cavities. In fact, in embodiments of the present invention, it is desirable to prevent such modes from occurring. The form of stimulated emission that does not rely on an optical oscillator, or is generated from an external seed light source, is known in the art as amplified spontaneous emission (ASE).

A characteristic of amplified spontaneous emission is that the fluorescence spectrum width of the fluorescent material is reduced from its nominal value. This is known in the art as gain narrowing. For instance, gain narrowing can reduce the width of the fluorescence spectrum to 30-40% of the nominal width (e.g. see Lasers, Anthony E. Siegman, University Science Books, 1986, pp. 281-283). This effect can be used as a benefit in the present application. For example, Ti:sapphire fluorescent material has an emission spectrum peak at approximately 800 nm and spectrum width of 200 nm when stimulated emission does not occur. There is rarely a need for radiation with more than 30 nm spectral width from the light source in fluorescence microscopy applications. Thus, the spectrum width of the fluorescent material can be reduced via gain narrowing so it better matches requirements of the application, e.g. fluorescence microscopy which requires a high brightness, narrow bandwidth, light source at a particular wavelength. Potentially, it is possible to output more usable optical power from the light source at the desired wavelength when gain narrowing is used to concentrate more optical power within the spectral width of the emission band. In addition, a narrower emission band places less stringent demands on special filters required with conventional light sources in fluorescence microscopy (i.e. bandpass filters or other filters that allow only a narrow wavelength band of radiation to pass or be reflected) because there is less out-of-band optical radiation to filter out of the signal.

Geometric Optical Design Considerations for the Wavelength Conversion Module

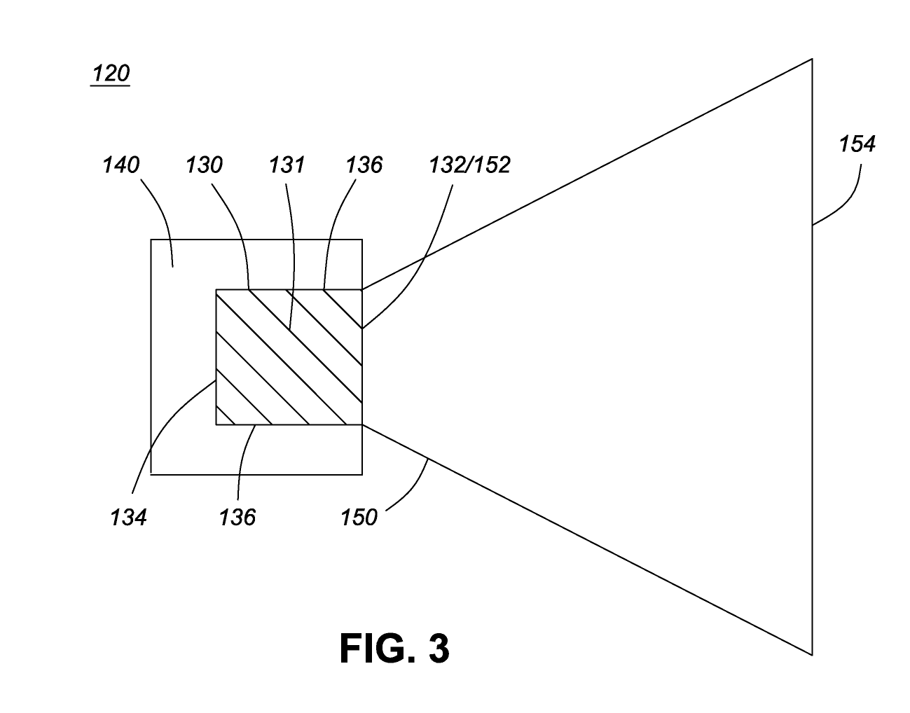

An enlarged cross-sectional view of the wavelength conversion module 120 comprising optical element 130 of photoluminescent material 131 is shown in FIG. 3. The fluorescence emission from the fluorescent material 131 is isotropic, meaning that the converted radiation is emitted equally in every direction (omnidirectional) regardless of the original direction of the absorbed radiation. Because the fluorescence or converted radiation 122 is emitted omnidirectionally within fluorescent material 131, only a fraction of the converted energy directly exits surface 132 of the optical element 130 and reaches the input aperture 152 of the optical concentrator 150, as represented in FIG. 3. In order to further improve the fraction of energy reaching the aperture of the optical concentrator 150 and therefore improve the overall amount of converted energy that is usable, preferably, other surfaces of the fluorescent material 131 are provided with a coating 134 and 136 of a material with a high optical reflectance at the emission wavelength. For example, a silver coating on surfaces 134 and 136 would reflect approximately 98% of impinging optical radiation.

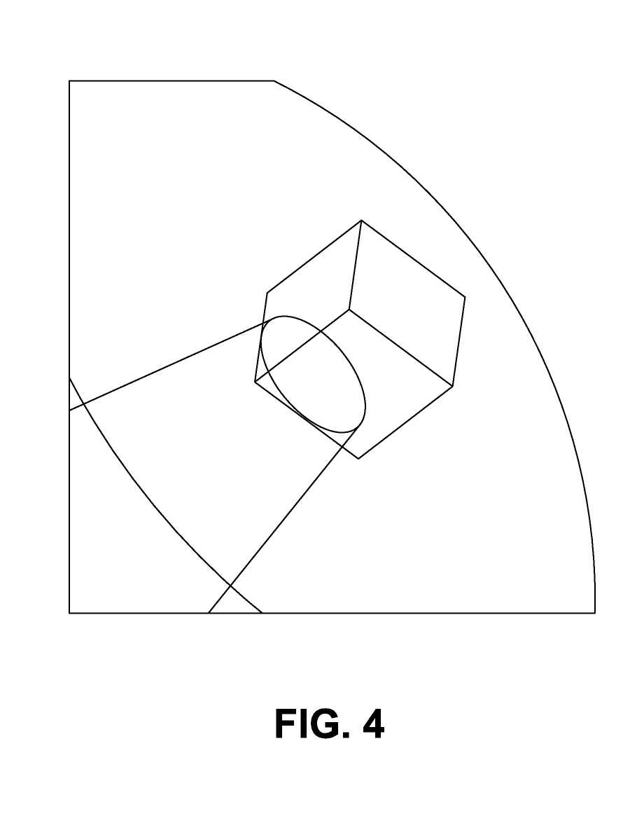

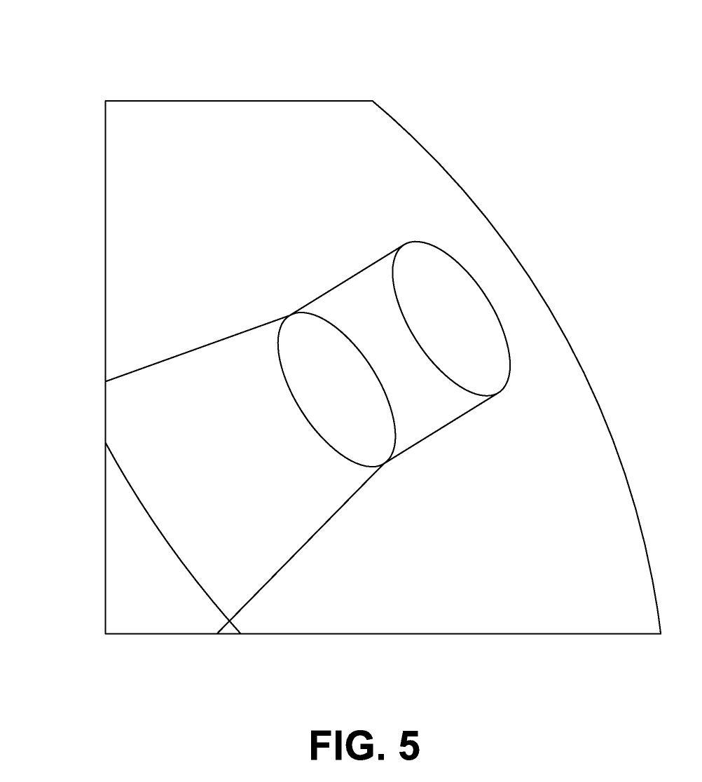

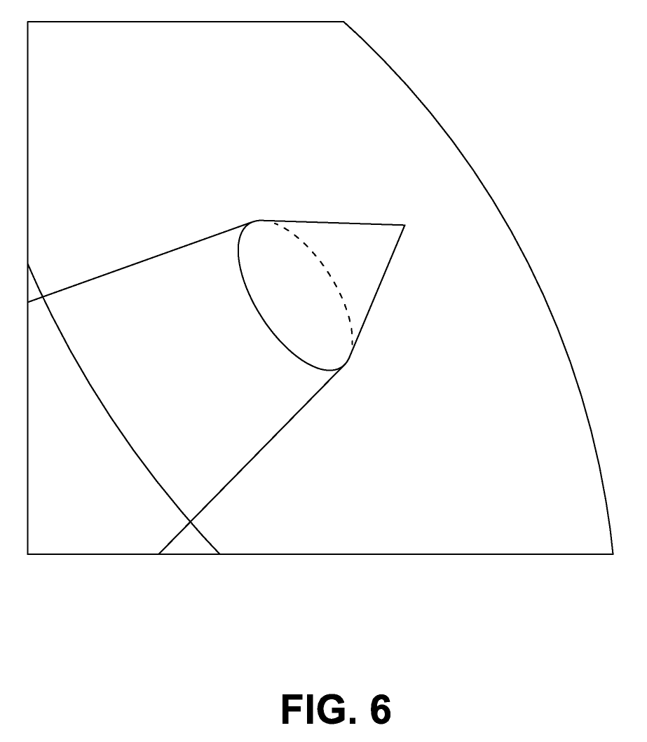

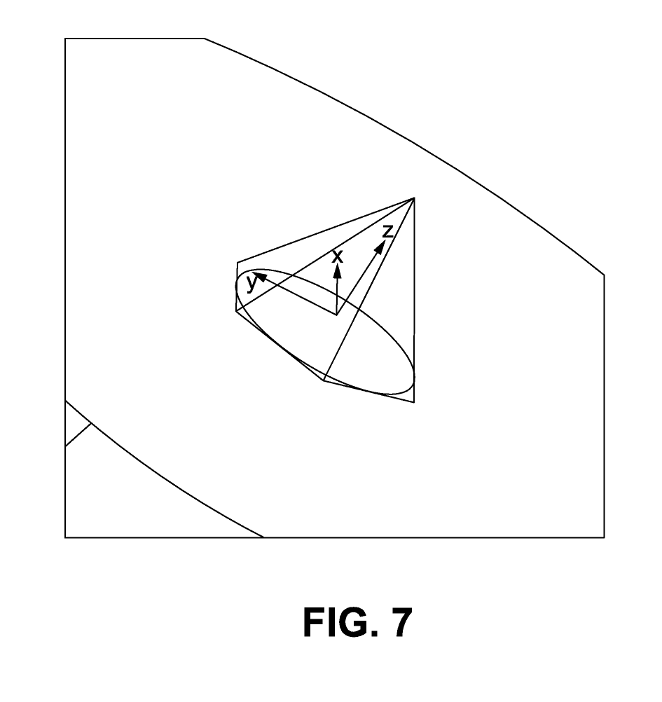

By way of example, the wavelength conversion module 120 according to this embodiment, as illustrated in FIG. 1 has cylindrical body of wavelength conversion medium 131 having a diameter and length of 0.9 mm, and is excited by a laser comprising a solid state laser or laser diode, to provide a compact arrangement. FIGS. 4, 5, 6 and 7 illustrate optical elements 130 of different shapes, comprising a cube, cylindrical rod, cone and multifaceted pyramid coupled to a conical optical concentrator 150, used for optical modeling.

Each of these shapes has advantages and disadvantages in terms of optical performance and manufacturability. The cube and cylinder are easiest and least costly to produce when it comes to cutting and polishing the fluorescent material. Optical modeling shows that the cone and pyramid offer distinct optical performance advantages over the cube and cylindrical rod. In the case of the cone or pyramid, converted radiation that is generated with material, will reach the output surface 132 or interface with aperture 152 of the optical concentrator 150 with typically one or two optical reflections. In the case of the cube and cylinder, because of the orientation and shape of their surfaces, and total internal reflection, a larger fraction of the converted radiation is trapped within the material 131. Radiation can reflect many times without reaching the output 132 to the optical concentrator. Since each reflection has some optical power loss (i.e. typically several percent loss, from optical absorption) then the overall power reaching the interface 132 is lower than for the conical or pyramidal shapes. For this reason the conical and pyramidal shapes offer better output coupling efficiency to the optical concentrator.

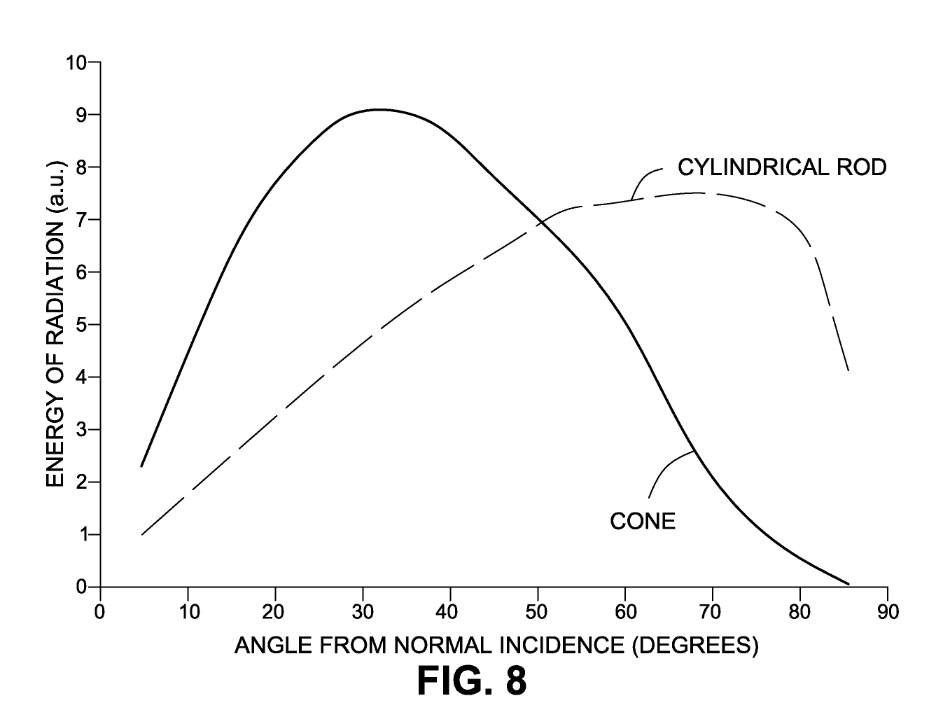

In addition, if radiation impinges on the interface between the wavelength conversion medium and the optical concentrator with an angle that surpasses the so-called critical angle, i.e. the threshold at which total internal reflection occurs, then the radiation will not enter the concentrator. The critical angle is dependent on the difference in refractive index at the surface or interface between the wavelength conversion element and the optical concentrator. In the case of the Ce:YAG fluorescent material and an air optical concentrator, the critical angle is only 33.8 degrees from normal incidence. FIG. 8 shows the results of computer modeling of the distribution of radiation energy vs. angle of impinging radiation on aperture 132 for an optical element made of this material. It is apparent that the optical element 130 of conical or pyramidal shape has a distribution of radiation closer to normal incidence than the cylindrical rod or cubic shapes.

Results from computer modeling show the overall coupling efficiency of an optical element comprising a simple cone or pyramid is several times better than the cylindrical rod or cubic shapes because of the fewer overall number of reflections at surfaces or interfaces of the body of fluorescent material 131 and the improved angular distribution of radiation impinging on the optical concentrator 150.

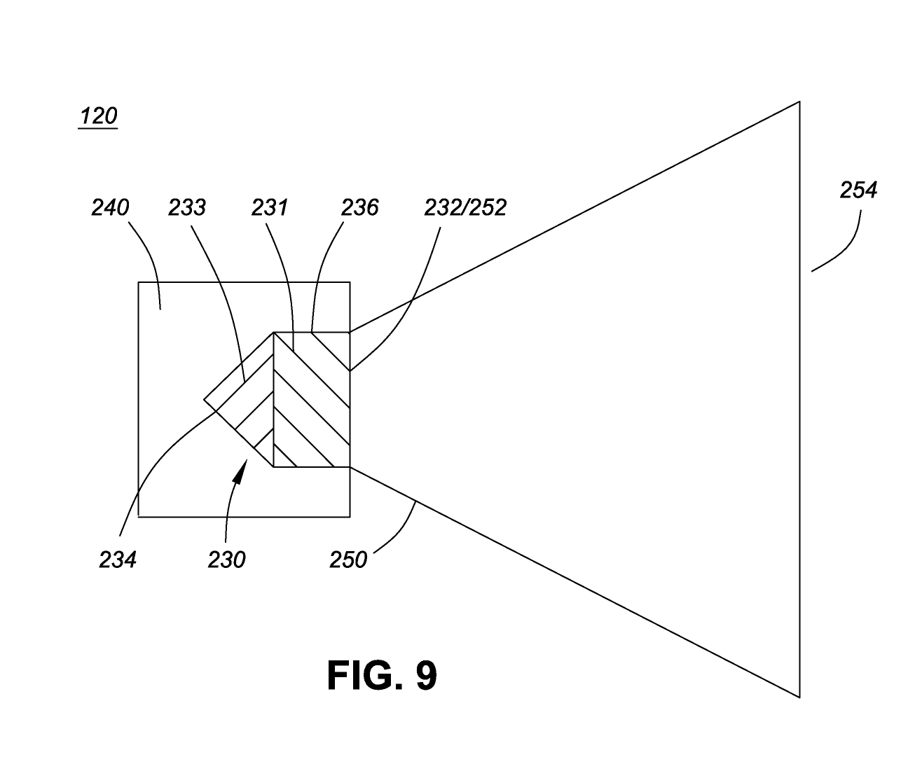

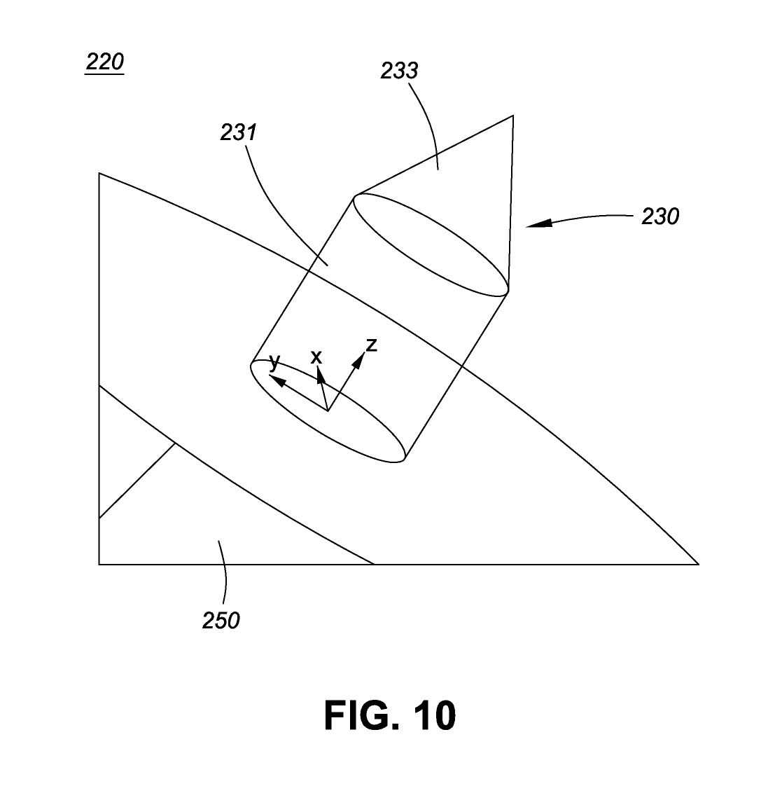

Alternatively, a combination of shapes and materials could be used to improve optical performance over the simple cube or cylindrical rod. This could be designed so one could benefit both from cost and ease of manufacturability and acceptable optical performance. For example, in a wavelength conversion module 220 according to a second embodiment, a preferred design for the shape of the body of the optical element 230 of the fluorescent material comprises a short cylindrical portion 231 that is bonded with or contiguous with a conical reflector portion 233, as shown in FIG. 9 and FIG. 10. The cylindrical portion 231 would be a selected fluorescent material e.g. Ce:YAG to provide fluorescence at the desired wavelength. The conical portion 233 could also be the same material, or would preferably be a glass material, or another material, such as sapphire or undoped YAG, that has a similar index of refraction as the fluorescent material 231 and is transparent at the wavelength of the photoluminescence. These variations of shapes and materials would be designed to achieve a best compromise of performance versus cost, and manufacturability.

Modeling of the above proposed shapes for the fluorescent material assumed polished surfaces 134, 136 or 234, 236 of the optical element 130 or 230 which may be coated with a reflective material so that these surfaces of the optical element act as a reflector for the photoluminescence emission. Another design variant would be to leave surfaces, e.g. 136 or 236, of the optical element unpolished so that radiation is not purely specularly reflected but scattered to some degree. This is especially important in the case of laser crystal fluorescent material as it would reduce the chance of forming of un-intended eigenmodes (a.k.a as cavity modes or optical resonances). Such modes would be difficult to control and could potentially cause loss of optical performance, optical damage to components, un-intended very high radiance, or temporal instability in the optical output, for example.

Output Optics and Optical Concentrator

An illumination system 100 comprising a light source 110, according to an embodiment of the invention such as illustrated in FIG. 1, may be used for applications such as microscopy. In this case, the illumination system is coupled to a microscope using coupling optics and/or a light guide (not shown). In order to obtain the highest coupling efficiency of converted radiation from the fluorescent material to the microscope objective plane, the size of the emission area of the fluorescent material must be quite small because of the optical principle conservation of étendue, or as is sometimes known, geometric extent. For example, if using a standard liquid light-guide with a diameter of 3 mm, the emission area of the optical element 130 should be 0.9 mm or less in diameter. In some cases, for coupling to a 1 mm fiber, a smaller diameter may be required for efficient coupling.

The radiation emitted from the fluorescent material has an angular distribution from −90 to +90 degrees from the surface's normal. The optical concentrator 150, or as is sometimes known as a θ-θ converter (theta-theta converter), is a non-imaging device that can efficiently transforms the converted light emitting from the fluorescent material from a 180 degree emission pattern to a smaller angular distribution. The concentrator shown has a simple conical surface profile but other profiles can be used. Most notably the profile may have a parabolic function and is known as a Compound Parabolic Concentrator (CPC). The embodiment described above uses the conical profile over the CPC because optical performance is approximately the same, but the simple conical shape is easier and less expensive to manufacture. However, a CPC or other optical concentrator with a more complex profile may be preferred.

The optical concentrator 150 described above may be an air concentrator, as opposed to a dielectric concentrator, i.e. the concentrator 150 may take the form a hollow metal cone, in which case the transmitting media is air. Embodiments of the invention are not restricted only to air concentrators. In fact, dielectric concentrators using a material such as glass, or sapphire, or undoped YAG, would provide certain advantages over the air concentrator. For instance, the total internal reflection and reflective losses that occur at the aperture between the wavelength conversion medium and the air concentrator are significantly reduced or substantially eliminated if the material of the concentrator and the fluorescent material, have closely matched refractive indices.

In addition, another advantage of the dielectric concentrator over the air concentrator is that heat produced in the fluorescent material during the optical conversion process can be more effectively dissipated via diffusion through the concentrator aperture 152 into the bulk of the concentrator 150.

The mounting or holder 140 for the fluorescent material 131 serves two purposes in the apparatus. The first is to mechanically hold the fluorescent material precisely in place in reference to the other optical components, i.e. it provides an optical mount to maintain optical alignment. The second is to provide thermal management, i.e. cooling of the fluorescent material. Indeed, the latter will produce heat because some, not all, of the absorbed laser energy will be converted into the optical radiation, i.e. dependent on the quantum yield as noted above. For example, Ce:YAG fluorescent material has a very high quantum yield and converts approximately 50% of the excitation laser radiation into optical emission at the desired output wavelength. Part of the absorbed laser radiation may be emitted at other wavelengths, but mostly it will be dissipated as heat and will cause the temperature of the fluorescent material to increase. If the fluorescent material is not cooled, the temperature may rise to several hundred degrees Celsius, which might reduce the optical conversion performance of the material, which is known in the art as thermal quenching. Having the fluorescent material in thermal contact to its holder causes the heat generated within the fluorescent material to diffuse into the holder and therefore reduces the temperature of the fluorescent material. Not shown in the diagram are other optional elements that may be included to further cool the fluorescent material, such as a heatsink or fins on the holder and/or a fan for air cooling of the holder.

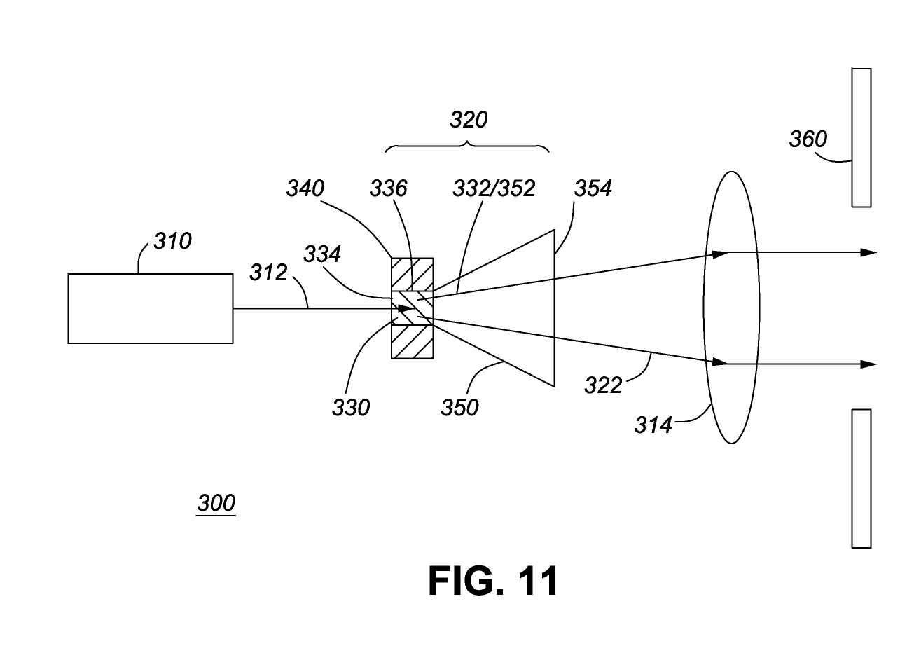

FIG. 11 illustrates schematically an illumination system comprising a wavelength conversion element according to another embodiment. In this embodiment, the optical configuration is arranged differently, so that the collimated light output 312 from the laser 310 is directed into the backside of the optical element 330 of the wavelength conversion element 320 via input surface or aperture 334, where it is absorbed by the wavelength conversion medium 331, and then the converted light 222 emitted from the front surface or aperture 332 of the wavelength conversion element 330 where it is directed via the optical concentrator 350 through the lens 314 to the aperture 360 of the illumination system. The flat surface 334 of the wavelength conversion element 330 may be provided with a dichroic coating, such that there is little reflection of the laser radiation 312 and high reflection of the converted radiation 332 to improve the optical performance and improve extraction of light at the converted wavelength. Additionally, for further improvement of the optical performance the surface 336 of the fluorescent material 331 within the thermal mounting/holder 240 may comprise a dichroic coating that has high optical reflection to the laser radiation 312 and little reflection to converted radiation.

Optionally, in alternative embodiments or variants of the embodiments described in detail herein, other input optical components (not shown), such as, but not limited to, a lens or an optical concentrator, in the optical path between the laser and the fluorescent material of the wavelength conversion element may be provided in order to better concentrate the laser radiation into the fluorescent material. A light source and the wavelength conversion module according to embodiments of the present invention is suitable for use with solid state lasers, or other lasers as the excitation light source, and for either continuous wave or pulsed operation.

By way of example, an illumination system comprising a solid state laser and a wavelength conversion module to provide a 200 mW light output at the converted wavelength may be obtained by using a single solid state laser consuming about 2 to 3 Watts of electrical energy. For comparison, a similar light output might require coupling of 80 LEDs consuming about 100 W of input power to obtain a similar light output. For practical reasons it will be apparent that an arrangement using a fluorescent rod of the type disclosed by Brukilacchio, would also require a larger volume of the wavelength conversion medium with sufficient surface area for coupling to multiple LEDS.

In contrast, the light output of a laser or laser diode may be more readily and tightly collimated or focused into a compact wavelength conversion module as described in this application. As mentioned above, for coupling to a light guide or optical fiber having a 3 mm aperture, the wavelength conversion medium may be crystal or optical element of about 0.9 mm diameter and having a similar length along the optical axis, i.e. 1 mm or 2 mm. With a solid state excitation laser, or laser diode, and input and output optics comprising an optical concentrator and/or lenses, a compact high brightness illumination system may be provided such that the unit size may be about 5 cm×5 cm×5 cm or less. While the illumination system and the compact wavelength conversion module may have applications for microscopy, in particular fluorescence microscopy, it may also have applications for endoscopy or other applications requiring coupling of a high brightness light source to a small aperture light guide or optical fiber.

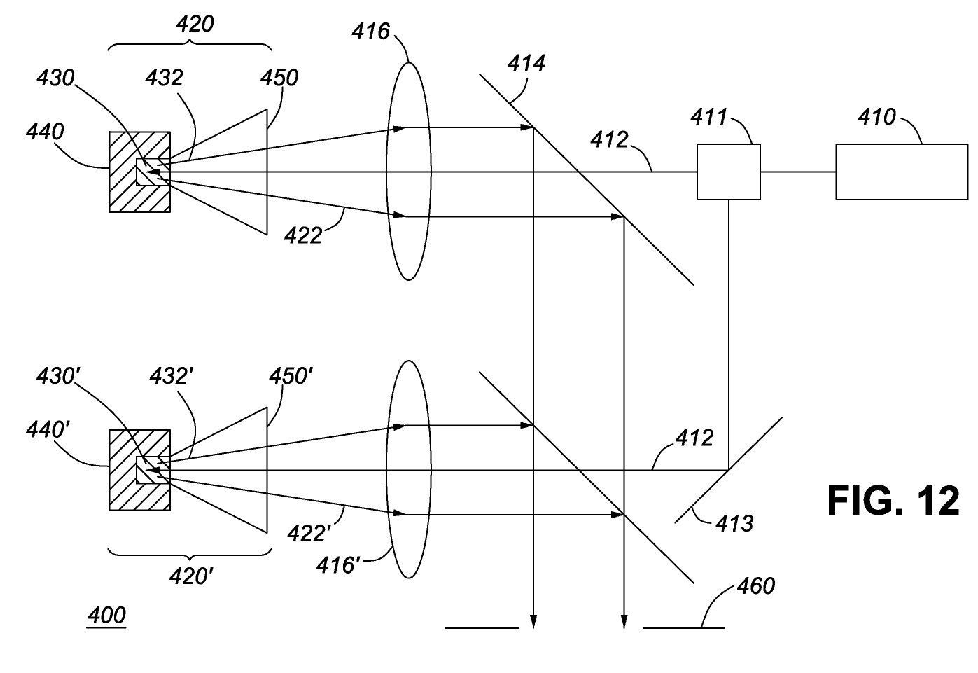

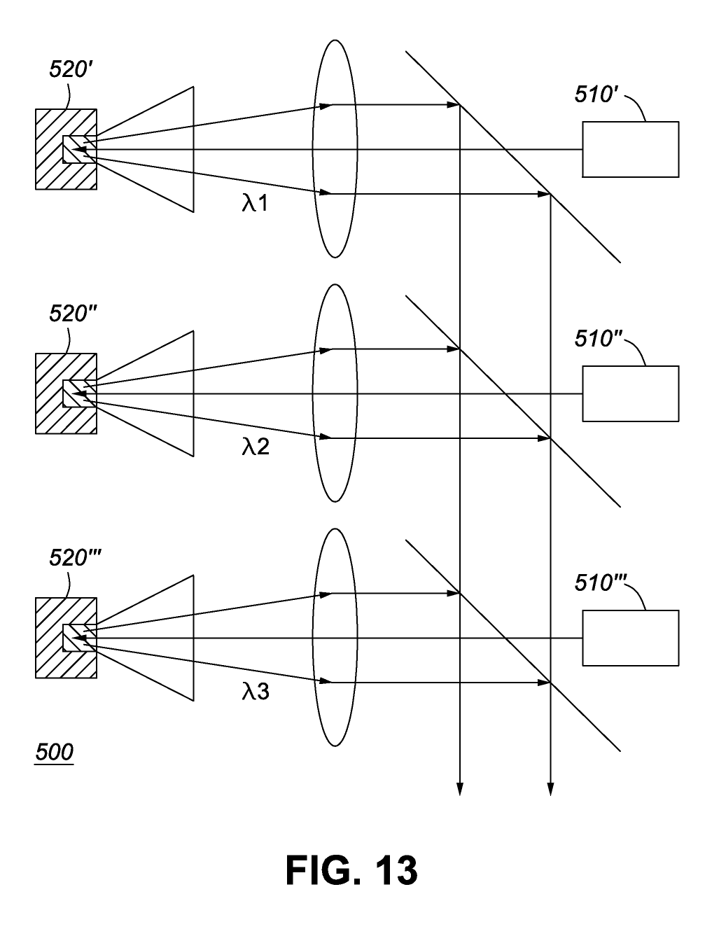

FIGS. 12 and 13 illustrate illumination systems 400 and 500 according to other embodiments comprising a plurality of two or more wavelength conversion modules for providing high brightness light output at one of several different wavelengths.

FIG. 12 shows an arrangement 400 comprising a single laser excitation source 410, optically coupled via a laser beam switching device 411 and a minor 413, to two separate wavelength conversion modules 420 and 420′. The latter may comprise different wavelength conversion materials 430 and 430′ that can be excited by the same laser wavelength to provide light of two different wavelengths 422 and 422′, respectively. Other optical elements for concentrating the laser excitation light or extracting the converted light are similar to those shown in the arrangement of FIG. 1, and comprise optical concentrators 450 and 450′, lenses 416 and 416′, output aperture 460, for example.

FIG. 13 shows another arrangement 500 of a plurality of wavelength conversion modules 530′, 530″ and 530″' each coupled via a respective lens and optical concentrator with their own excitation laser source 510′, 510″ and 510″′. For example, each wavelength conversion module may comprise a different wavelength conversion material to provide converted light of a different wavelength, i.e. λ₁, λ₂ and λ₃, and wavelength of each laser 510′, 510″ and 510″′ may be individually matched to provide efficient excitation of the respective wavelength conversion medium to generate light of the selected converted wavelength, i.e. λ₁, λ₂ and λ₃.

It will also be appreciated that other embodiments comprising arrangements of a plurality of wavelength conversion modules and one or more excitation lasers may be provided for generation of light output at one of several different wavelengths. The wavelength conversion modules may each be individually mounted or set in a thermally conductive holder as illustrated. Alternatively multiple modules may be thermally coupled to allow for use of a single cooling system such as a suitable heatsink or other thermally conductive holder and an air or liquid cooling system.

Although embodiments of the invention have been described and illustrated in detail, it is to be clearly understood that the same is by way of illustration and example only and not to be taken by way of limitation, the scope of the present invention being limited only by the appended claims.

1. An illumination system comprising;
a laser light source;
a wavelength conversion module comprising:
a high thermal conductivity holder;
an optical element comprising a wavelength conversion medium mounted in thermal contact with the holder;
the optical element having an optical aperture for coupling light of a first wavelength λₗ from the laser light source into the optical element for exciting photoluminescence emission therein at a converted wavelength λ_{f} and for extracting the photoluminescence emission;
an optical concentrator coupled to the aperture; and
reflector means of the optical element comprising a reflective surface or surfaces thereof for directing photoluminescence emission from the wavelength conversion medium into the optical concentrator for coupling the concentrated photoluminescence emission to an output aperture of the illumination system.

2. A system according to claim 1 wherein the reflector means of the optical element comprises a reflective surface or surfaces thereof in thermal contact with the holder.

3. A system according to claim 2 wherein said reflective surface or surfaces comprise a coating of a material having a high reflectance, preferably >94%, at the converted wavelength, and preferably also having a high reflectance at the laser wavelength.

4. A system according to claim 3 wherein the reflective coating is a broadband coating.

5. A system according to claim 3 wherein the coating comprises a dichroic coating.

6. A system according to claim 1 wherein the optical element is shaped as a cone, and the reflector means comprises a conical surface thereof.

7. A system according to claim 6 wherein the optical element has the form of a truncated cone.

8. A system according to claim 1 wherein the optical element comprises a body comprising said wavelength conversion medium having a shape comprising one of a cylinder, a cube, a rectangle, a cone, and a pyramid, a truncated cone or pyramid, or combinations thereof, and the reflector means comprises a reflective facet or facets of the shape to direct photoluminescence emission generated within the wavelength conversion medium towards the aperture of the optical element.

9. A system according to claim 8 where said facet or facets comprise a polished surface of the wavelength conversion medium and a coating with high reflectivity at the converted wavelength and at the laser wavelength.

10. A system according to claim 8 where said facet or facets comprise a diffuse reflectance surface or a surface texture to reduce specular reflection.

11. A system according to claim 8 wherein the shape of the optical element and reflective surfaces thereof form a substantially non-resonant optical cavity at the converted wavelength.

12. A system according to claim 1 wherein the optical element comprises a body having a first portion comprising the wavelength conversion medium and a reflector portion optically coupled thereto.

13. A system according to claim 12 comprising a cylindrical first portion of the body and a conical reflector portion.

14. A system according to claim 12 wherein the reflector portion comprises an optical medium that is substantially transparent at the laser wavelength and at converted wavelength and is index matched to the wavelength conversion medium.

15. A system according to claim 1 wherein the wavelength conversion medium comprises a body having a cylindrical portion coupled to a reflector portion of an optical medium having a conical shape, and wherein facets of the reflector portion and walls of the cylindrical portion comprises a coating having a high reflectivity at the converted wavelength, and are in thermal contact with the holder.

16. A system according to claim 1 for coupling to the input of an optical fiber or light guide having an optical aperture of less than 3 mm diameter, wherein the optical element has an optical aperture having a diameter of 0.9 mm or less.

17. A system according to claim 16 wherein the optical element has a length along the optical axis of substantially equal to the diameter, or less than 1 mm, or less than 2 mm.

18. A system according to claim 16 wherein the optical element has a length along the optical axis to provide an absorption depth such that greater than 50% of the incident laser radiation is absorbed.

19. A system according to claim 1 wherein the wavelength conversion medium comprises one of:
a) cerium doped yttrium aluminum garnet (Ce:YAG), Ce:YAG co doped with praseodymium and/or terbium, or other rare earth doped garnet material that emits luminescence at the converted wavelength; or
b) titanium doped sapphire or other materials capable of amplified spontaneous emission at the converted wavelength.

20. A system according to claim 1 wherein the wavelength conversion medium comprises one of a single crystal material, a polycrystalline material, a ceramic material or other host matrix material.

21. A system according to claim 1 wherein the optical element has a single input/output aperture, and input optics comprising the optical concentrator couple incident laser radiation into the input/output aperture of the optical element, and the reflector means reflects luminescence emission through the input/output aperture into the optical concentrator.

22. A system according to claim 1 wherein the holder acts as a heat spreader and further comprises cooling means for air cooling and/or liquid cooling.

23. A wavelength conversion module for an illumination system comprising:
a high thermal conductivity mounting;
an optical element having a body comprising at least in part a wavelength conversion medium capable of laser excitation by light of a first wavelength to generate photoluminescence emission at a converted wavelength;
the optical element being held in the mounting in thermal contact therewith;
the body of the optical element having a shape defined by one or more surfaces thereof forming a substantially non-resonant cavity to receive light of the first wavelength through an optical aperture into the wavelength conversion medium, and wherein the one or more of said surfaces form a reflector for directing photoluminescence from the wavelength conversion medium towards the optical aperture of the body.

24. A wavelength conversion module according to claim 23 further comprising an optical concentrator coupled to the optical aperture of the optical element.

25. A wavelength conversion module according to claim 23 wherein the wavelength conversion medium comprises one of Ce:YAG, Ce:YAG co-doped with terbium or praseodymium or other rare earth element; or other rare earth doped garnet having a suitable lifetime and optical absorption and emission spectrum; or titanium doped sapphire; or other materials capable of amplified spontaneous emission.

26. A wavelength conversion module according to claim 25 wherein wavelength conversion medium comprises one of a single crystal, a polycrystalline material, or a ceramic material.

27. A wavelength conversion module according to claim 23 wherein the body of the optical element comprises a geometric shape comprising one of a cube, a cylindrical rod, a cone, a multifaceted pyramid, a truncated cone, a truncated pyramid, or a combination thereof.

28. A wavelength conversion module according to claim 23 wherein the optical element comprises any one of:
a wavelength conversion medium shaped as a cone; or
a conical shaped body, wherein conical surfaces thereof form the reflector; or
a wavelength conversion medium shaped as a cone and the reflector comprises conical surfaces thereof having a high reflectivity at the converted wavelength and preferably also at the laser wavelength; or
a wavelength conversion medium shaped as one of a cylinder, cube, cone, or combinations thereof and the reflector comprises a surface or surfaces thereof having a high reflectivity at the converted wavelength and preferably also at the laser wavelength.

29. A wavelength conversion module according to claim 23 wherein the body of the optical element comprises a first portion comprising the wavelength conversion medium and a reflector portion comprising an index matched optical medium that is substantially transparent to the converted wavelength.

30. A wavelength conversion module according to claim 23 wherein body of the optical element comprises a first portion comprising the wavelength conversion medium, and a reflector portion comprising an index matched optical medium that is substantially transparent to the converted wavelength and the excitation wavelength.

31. A wavelength conversion module according to claim 30 wherein the first portion is shaped as a cylinder, and the reflector portion is shaped as a conical profile reflector.

32. A wavelength conversion module according to claim 24 wherein the optical concentrator comprises one or more of:
a concentrator having a conical profile; or
a compound parabolic concentrator, or
other complex profile concentrator; or
an air concentrator; or
a dielectric concentrator comprising an optical medium that is index matched to that of the optical element.

33. A wavelength conversion module according to claim 23 wherein the optical element comprises a first portion comprising a wavelength conversion medium bonded to a second portion comprising forming a reflector.

34. A wavelength conversion module according to claim 23 wherein the optical element comprises a wavelength conversion medium bonded to a dielectric optical concentrator comprising an index matched dielectric.
